(19) United States
(12) Patent Application Publication
(10) Pub. No.: US 2005/0247050 A1
(43) Pub. Date: Nov. 10, 2005

(54) Adsorption based ammonia storage and regeneration system

(75) Inventors: Wayne Scott Kaboord, Mequon, WI (US); Dawn Marie Becher, Random Lake, WI (US); Fred Joseph Begale, Oconomowoc, WI (US); Reg F. Crane, Elwick (GB); Steven M. Kuznicki, Edmonton (CA)

Correspondence Address: PAUL V. KELLER, LLC, 4585 LIBERTY RD., SOUTH EUCLID, OH, 44121, US

(73) Assignee: Eaton Corporation, Cleveland, OH (US)

(21) Appl. No.: 10/839,566

(22) Filed: May 5, 2004

(51) Int. Cl. F01N 3/10; F01N 3/00; C01B 21/00; B01J 8/00

(52) U.S. Cl. 60/286; 60/285; 60/295; 60/297; 60/301; 60/288

(57) ABSTRACT

One aspect of the invention relates to a device for storing ammonia for use in SCR on board a vehicle. The device comprises an adsorption bed with a high capacity for storing ammonia. The device can be designed to hold a long-lasting charge of ammonia comparable to a urea tank, but will not release substantial amounts of ammonia into the environment even if the device is accidentally ruptured. In one embodiment, the devices are charged at stationary locations. In another embodiment, the devices are charged by vehicle-mounted ammonia synthesis plants. The device facilitate the use of small ammonia synthesis plants that operate at low pressures and give low conversions. Preferably, the devices are operated through temperature swing adsorption.

### PRIORITY

This application is a continuation-in-part of U.S. Provisional Application No. 60/467,871, filed May 5, 2003.

### FIELD OF THE INVENTION

The present invention relates to the field of pollution control devices for internal combustion engines.

### BACKGROUND OF THE INVENTION

NOₓ emissions from vehicles with internal combustion engines are an environmental problem recognized worldwide. Several countries, including the United States, have long had regulations pending that will limit NOₓ emissions from vehicles. Manufacturers and researchers have put considerable effort toward meeting those regulations. In conventional gasoline powered vehicles that use stoichiometric fuel-air mixtures, three-way catalysts have been shown to control NOₓ emissions. In diesel powered vehicles and vehicles with lean-burn gasoline engines, however, the exhaust is too oxygen-rich for three-way catalysts to be effective.

Several solutions have been posed for controlling NOx emissions from diesel powered vehicles and lean-burn gasoline engines. One set of approaches focuses on the engine. Techniques such as exhaust gas recirculation, homogenizing fuel-air mixtures, and inducing sparkless ignition can reduce NOx emissions. These techniques alone, however, will not eliminate NOx emissions. Another set of approaches remove NOx from the vehicle exhaust. These include the use of lean-burn NOₓ catalysts, NOₓ adsorber-catalysts, and selective catalytic reduction (SCR).

Lean-burn NOx catalysts promote the reduction of NOₓ under oxygen-rich conditions. Reduction of NOx in an oxidizing atmosphere is difficult. It has proved challenging to find a lean-burn NOₓ catalyst that has the required activity, durability, and operating temperature range. Lean-burn NOₓ catalysts also tend to be hydrothermally unstable. A noticeable loss of activity occurs after relatively little use. Lean burn NOx catalysts typically employ a zeolite wash coat, which is thought to provide a reducing microenvironment. The introduction of a reductant, such as diesel fuel, into the exhaust is generally required and introduces a fuel economy penalty of 3% or more. Currently, peak NOx conversion efficiency with lean-burn catalysts is unacceptably low.

NOx adsorber-catalysts alternately adsorb NOx and catalytically reduce it. The adsorber can be taken offline during regeneration and a reducing atmosphere provided. The adsorbant is generally an alkaline earth oxide adsorbant, such as BaCO₃ and the catalyst can be a precious metal, such as Ru. A drawback of this system is that the precious metal catalyst and the adsorbant may be poisoned by sulfur.

SCR involves using ammonia as the reductant. The NOx can be temporarily stored in an adsorbant or ammonia can be fed continuousy into the exhaust. SCR can achieve NOx reductions in excess of 90%. SCR is widely considered to be the one proven technology for NOx control and has been selected for implementation by European heavy-duty vehicle manufacturers.

In connection with SCR, the provision of ammonia is a concern. Compressed or liquid ammonia on vehicles is considered an unacceptable safety and enviromental hazard. Alternatives include urea, which can be hydrolyzed as needed to form ammonia, and ammonia salts, such as carbamate, which can be decomposed to give ammonia. The European heavy-duty vehicle manufacturers in particular have chosen to create a distribution system for a 32.5% solution of urea in water (AdBlue). While this distribution system will be difficult and expensive to create and maintain, no better alternatives have been identified.

U.S. Pat. Appl. No. 2003/0136115 suggests an emission control systems in which ammonia is generated by a reaction between NO with H₂. During a special rich mode of engine operation, the ammonia is generated in a first catalytic converter and stored in a second, downstream catalytic converter. During a normal lean mode of operation, NO is reduced by the ammonia in the second catalytic converter. When sensors indicate the stored ammonia is exhausted, the engine is returned to rich operation for a period to regenerate the ammonia.

There continues to be a long felt need for reliable, affordable, and effective systems for removing NOx from the exhaust of diesel and lean-burn gasoline engines.

### SUMMARY OF THE INVENTION

The following presents a simplified summary in order to provide a basic understanding of some aspects of the invention. This summary is not an extensive overview of the invention. It is intended neither to identify key or critical elements of the invention nor to delineate the scope of the invention. Rather, the primary purpose of this summary is to present some concepts of the invention in a simplified form as a prelude to the more detailed description that is presented later.

One aspect of the invention relates to a device for storing ammonia for use in SCR on board a vehicle. The device comprises an adsorption bed with a high capacity for storing ammonia. Preferably, the device can store at least about 10% ammonia by weight and preferably the device is adapted to release the ammonia by heating. An ammonia storage device according to the invention can be designed to hold a long-lasting charge of ammonia comparable to a urea tank, but will not release a substantial amount of ammonia into the environment even if the device is accidentally ruptured.

Another aspect of the invention relates to systems and methods of supplying ammonia to vehicles for SCR. The ammonia is adsorbed into an adsorption bed of a storage device. The device is mounted on a vehicle and used to treat the vehicle exhaust. After the supply of ammonia is depleted, the device can be replaced by another with a fresh charge.

A further aspect of the invention also relates to a vehicle provided with an ammonia synthesis reactor. Ammonia precursors undergo partial conversion as they pass through the reactor. Ammonia is adsorbed into an ammonia storage device and unconverted reagents are recycled through the reactor for further conversion. After the ammonia storage device is charged, it is used to supply an SCR reactor. The invention allows for efficient use of a low pressure ammonia synthesis reactor in which complete conversion of reagents cannot be expected. Preferably, the vehicle is provided with at least two ammonia storage devices whereby one can be supplying ammonia while the other is being charged.

A still further aspect of the invention relates to a vehicle provided with two devices that store ammonia by adsorption. The vehicle is adapted to supply ammonia from the first device to an SCR reactor and, at a point generally corresponding to depletion of ammonia from the first device, to switch to supplying ammonia from the second device. One of the devices can be charging while the other is being used. Alternatively, the depleted devices can be replaced or recharged during a vehicle stop.

To the accomplishment of the foregoing and related ends, the following description and annexed drawings set forth in detail certain illustrative aspects and implementations of the invention. These are indicative of but a few of the various ways in which the principles of the invention may be employed. Other aspects, advantages and novel features of the invention will become apparent from the following detailed description of the invention when considered in conjunction with the drawings.

### BRIEF DESCRIPTION OF THE DRAWINGS

FIG. 1 is an illustration of an ammonia storage device comprising a porous-walled monolith;

FIG. 2 is an illustration of an ammonia storage device comprising a cohesive mass of adsorbant pellets;

FIG. 3 is an illustration of an ammonia storage device comprising a stack of coated screens;

FIG. 4 is a cross-sectional view of the ammonia storage device of FIG. 3;

FIG. 5 is an illustration of an ammonia storage device comprising an annular monolith adsorbant bed and a central channel for heat exchange;

FIG. 6 is a cross-sectional view of the ammonia storage device of FIG. 5;

FIG. 7 is another cross-sectional view of the ammonia storage device of FIG. 5;

FIG. 8 is an illustration of an ammonia storage device comprising a rolled, coated screen adsorbant bed surrounding a central channel for heat exchange;

FIG. 9 is a cross-sectional view of the ammonia storage device of FIG. 8;

FIG. 10 is an illustration of an ammonia storage device comprising coated screens radially arrayed around a central channel;

FIG. 11 is a cross-sectional view of the ammonia storage device of FIG. 10;

FIG. 12 is a schematic illustration of an ammonia synthesis plant.

### DETAILED DESCRIPTION OF THE INVENTION

One aspect of the present invention relates to the idea of generating ammonia in small synthesis plants and storing the ammonia by adsorption. A synthesis plant can form ammonia from H₂ and N₂ or from H₂ and NO. H₂, N₂, and NO can be generated from just air, fuel, and water. The synthesis plant can be stationary or vehicle-mounted. Storing the ammonia in adsorption beds serves the dual functions of extracting ammonia from a dilute stream, which is the typical product of a small scale ammonia synthesis plant, and of providing a safe system for storing substantial quantities of ammonia on vehicles.

An ammonia storage device according to the present invention is adapted for use in a vehicle exhaust system. Vehicle exhaust systems create restriction on weight, dimensions, and durability. For example, an adsorption bed for a vehicle exhaust systems must be reasonably resistant to degradation under the vibrations encountered during vehicle operation. A vehicle is typically powered by an internal combustion engine burning a fuel such as diesel, gasoline, natural gas, or propane and produces an exhaust.

The mass of an ammonia storage device according to the present invention can be substantial in terms of the device sizes typically found in a vehicle exhaust system. To limit the total mass, the adsorbant bed preferably comprises a high loading of adsorbant per unit bed mass. Preferably, an adsorbant bed according to the present invention comprises at least about 40% adsorbant by weight, more preferably at least about 60%, still more preferably at least about 80%, and most preferably at least about 90%. The weight of an adsorbant bed includes any inert substrate and any binders, but does not include any housing.

Adsorbant beds according to the invention generally carry more adsorbant per unit volume than prior art beds. In one embodiment, an adsorbant bed according to the invention is at least about 20% adsorbant by volume, in another embodiment, at least about 35% adsorbant by volume, in a further embodiment, at least about 50% adsorbant by volume, and in a still further embodiment, at least about 65% adsorbant by volume.

Temperature swing adsorption is the preferred method of operating an ammonia storage device according to the present invention. In contemplation of temperature swing adsorption, ammonia storage devices according to the invention may be provided with mechanisms for heating and/or cooling. For example, an adsorption bed can be permeated with heat-exchange passages in fluid isolation from the passages provided for adsorbed and desorbed gases. A hot or cold fluid is circulated through the heat-exchange passages to heat or cool the adsorption bed. A cooling fluid could be, for example, engine coolant or ambient air. A heating fluid could be, for example, hot exhaust or a fluid that draws heat from hot exhaust or a heat-producing device such as an ammonia synthesis reactor, a catalytic reformer, or an adsorber.

In one embodiment of the invention, the ammonia storage device has a small number of heat-exchange passages, for example less than five, and preferably just one. A single channel can pass through the center of the adsorption bed. A central channel is typically rather large, having for example a cross-sectional area of at least about 1 square inch. The channels can be provided with heat exchanger fins. Advantages of heat exchange through a single central passage include simplicity, low pressure drop, and easy coupling and decoupling from a vehicle.

An ammonia storage device can also include a provision for electrical heating. Where the adsorption bed includes a metal substrate, the metal substrate can be used as an electrical resistance heater. An adsorption bed can also be permeated by wires for electrical resistance heating.

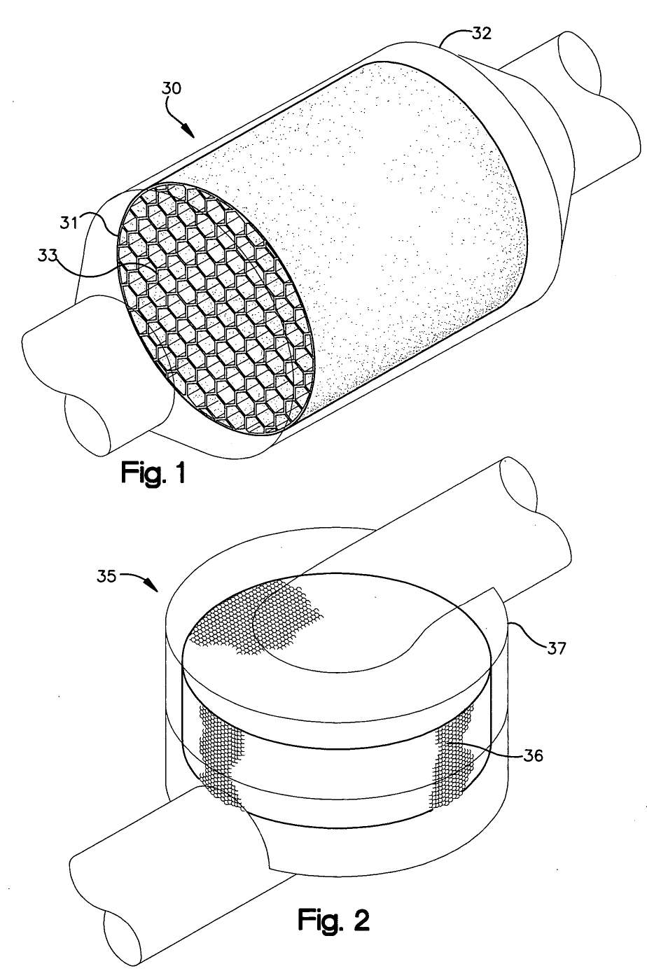

FIG. 1 illustrates an ammonia storage device 30 with a design for improving the utilization of an adsorbant, especially a molecular sieve adsorbant that has very small pores. The ammonia storage device 30 comprises a monolith 31 within a housing 32. The monolith 31 is preferably a self-supporting structure without an inert substrate. The monolith can be cast or extruded. Casting may be accomplished by pressing a coarse mixture of adsorbant pellets and binder into a mold and then curing the mixture. Alternately, the pellets can be pored into the mold and sintered to form a cohesive mass. Extrusion can be carried out in a similar fashion with heat applied at the point of extrusion to cure the binder or sinter the pellets. The pellets themselves are typically a mixture of adsorbant and binder. The walls 33 of the monolith 31 have a macro-porous structure, whereby the diffusion path length from the macro-pores to the innermost parts of the walls 33 is substantially less than the diffusion path length from the channels to the centers of the walls. Because the monolith 31 lacks an inert substrate, it comprises a large fraction of adsorbant by weight. Preferably, the walls of the monolith, exclusive of the channel volume and exclusive of any pores having an effective diameter less than 1 μm (an effective diameter being defined with reference to mercury porosimetry) have a void volume fraction of at least about 0.1, more preferably at least about 0.2, still more preferably at least about 0.3.

FIG. 2 illustrates an ammonia storage device 35 comprising a cohesive mass of pellets 36 in a housing 37. Loose pellets in a packed bed have a tendency to erode when mounted on a vehicle. The ammonia storage device 35 mitigates this problem by forming the pellets into a cohesive mass. The pellets can be formed into a cohesive mass by, for example, sintering the pellets together or mixing them with a binder. The individual pellets are preferably themselves made up of smaller pellets. Smaller pellets can themselves be formed onto larger pellets by a binder or a sintering process. The intersticies between the larger pellets correspond to the channels of the monolith 31 and the voids in the pellets (intersticies between the smaller pellets, where appropriate) correspond to the voids in the walls of the monolith 31. The comments regarding preferred composition and void sizes for the monolith 31 apply to the cohesive mass 36. The ammonia storage device 35 is provided in a pancake design. A pancake design gives a large cross-sectional area in the direction of flow and thereby reduces the pressure drop for a given bed volume.

The packed bed designs of the present invention can provide very high adsorbant densities. Density can be increased by using a mixture of pellet sizes, for example, a mixture of 1/16 inch and 1/8 inch pellets.

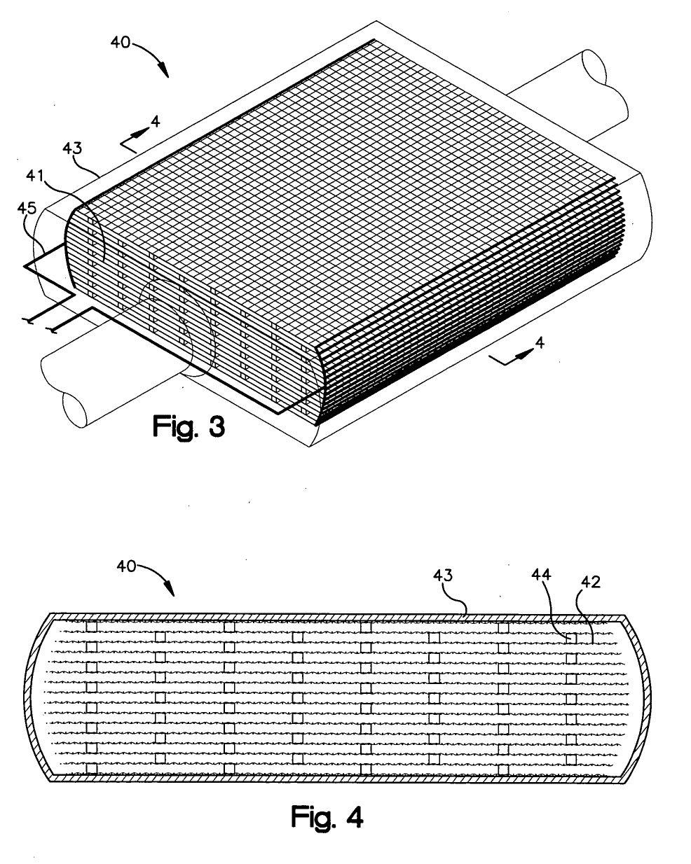

FIGS. 3 and 4 illustrates a device 40 in the form of a stack 41 of coated metal screens 42 in a housing 43. An adsorbant forms a coating over the screens 42. Exhaust flows between the screens 42. The spacing between the screens is controlled by spacers 44. The openings in the screens 42 provide additional surface area for the adsorbant. Optional electrical leads 45 are connected to the screens along either side of the adsorbent bed. By connecting a power source to the electrical leads 45, the device 40 can be heated.

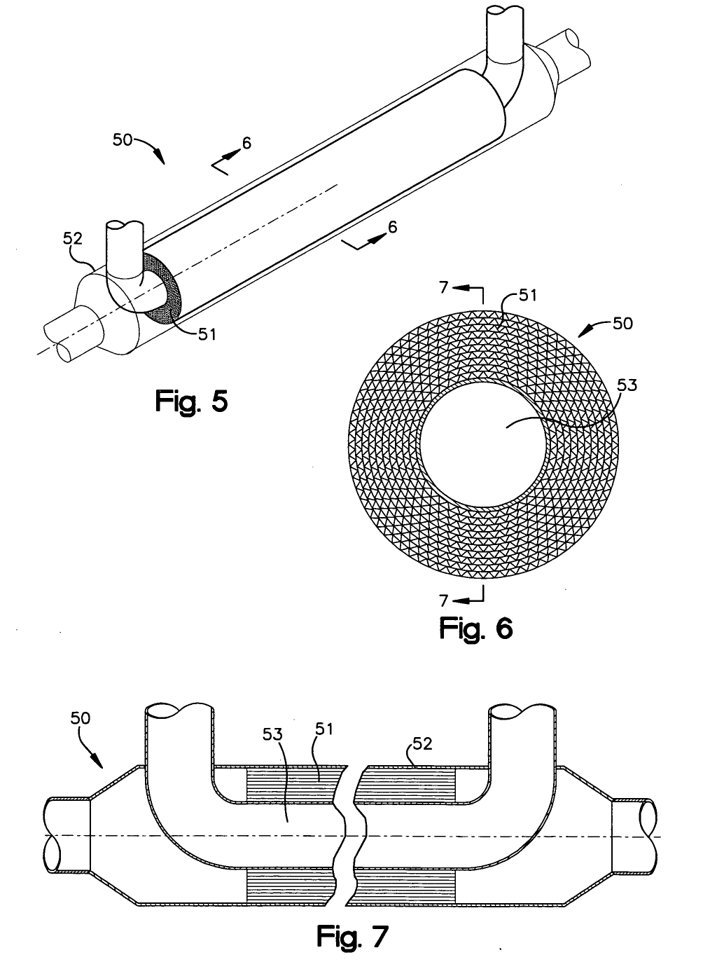

FIGS. 5 to 7 illustrate a device 50 comprising an annular monolith 51 enclosed in a housing 52 and surrounding a central channel 53. The central channel 53 is in fluid isolation from the monolith 51, but can be used to heat or cool the monolith. For example, the monolith can be heated by passing hot exhaust through the central channel 51 and cooled by driving ambient air through the central channel 51. The monolith itself can have any suitable structure. In one embodiment, the monolith is made up of metal foil coated with an adsorbant. The structure can be made by spiraling together two rolled sheets of metal, one flat and one articulated, about the central channel. A metal foil substrate can be used for electrical resistance heating. The adsorbent bed occupying the annular region can alternatively be, for example, a cohesive mass of pellets or layered coated screening.

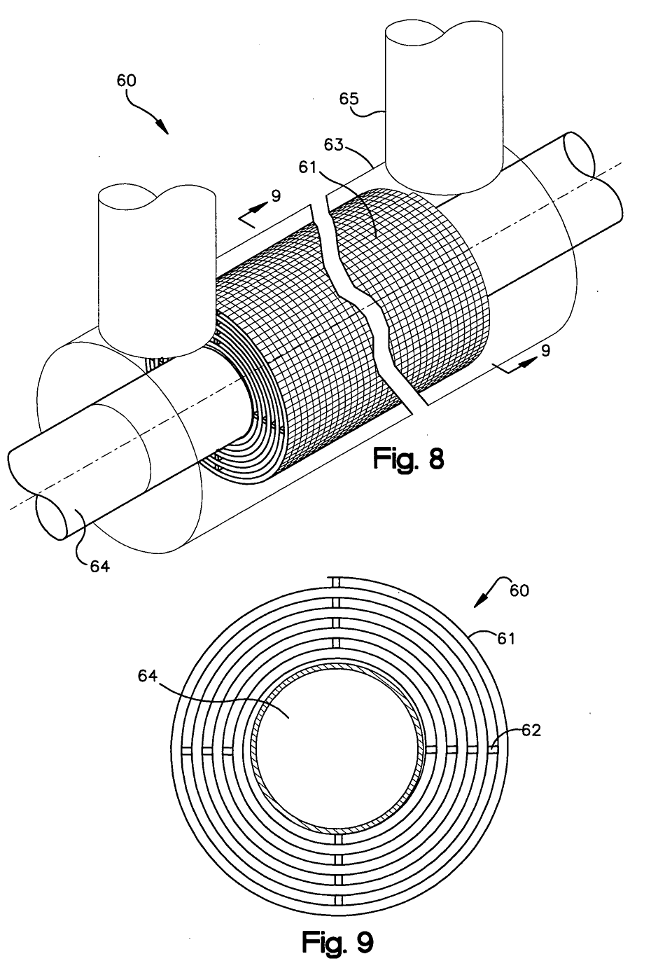

FIGS. 8 and 9 illustrate an ammonia storage device 60 that has a housing 63 and a central channel 64. The adsorbent bed 61 comprises a metal screen coated with adsorbant and rolled into a hollow cylinder to form roughly annular passages. The widths of the passages are controlled by spacers 62. The housing 63 is different from the housing 53 of the ammonia storage device 50 in that the central passage vents out the ends rather than the sides. These housings can be interchanged.

The housing 52 and 63 and their associated beds and central channels can have any appropriate dimensions for a particular application. The length, central channel diameter, and bed outer diameter are selected in view of the required volume, bed thermal conductivity, requirements for temperature uniformity, requirements for heat exchange, and limitations on pressure drops through the bed and central channel. Mathematical calculations and/or computer simulations can be used to identify appropriate designs for particular applications. The frontal area of the bed and channel is typically from about 4 square inches to about 120 square inches, more typically from about 7 square inches to about 50 square inches. The inner channel diameter is typically from about 1 to about 3 inches. The difference between the inner and the outer channel diameter is typically from about 1 to about 3 inches. The length to outer diameter ratio is typically from about 12:1 to about 3:1.

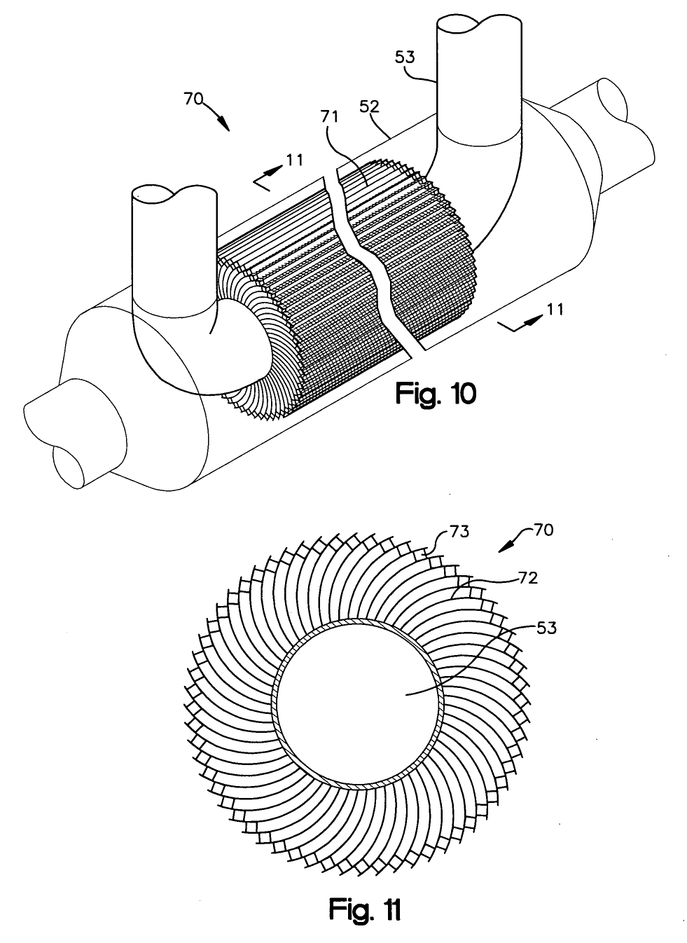

FIGS. 10 and 11 illustrate an ammonia storage device 70 using the housing 52 and the central channel 53. The ammonia storage device 70 comprises an adsorbant bed 71 made of metal screens 72 coated with adsorbant or catalyst, attached edgewise, and arrayed radially about the central channel 53. Attaching the screens 72 edgewise to the central channel 53 may facilitate heat transfer between the adsorbant bed 71 and the central channel 53. Optionally, the central channel 53 includes heat-exchanger fins extending from the edges of the channel towards its interior. The screens 72 curve as they extend away from the central channel 53. The curvature limits or eliminates the tendency for the spacing between screens 72 to increase with distance from the central channel 53. The curvature also makes the ammonia storage device 70 more compact and may further facilitate heat exchange with a fluid in the central channel 53. The spacing between screens is controlled with spacers 73.

In one embodiment, the adsorption bed has a large capacity for adsorbing NH₃ at 25° C. and one atmosphere pressure. In this and similar contexts, one atmosphere pressure means, in substance, one atmosphere of pure ammonia. Pressures are absolute pressure unless otherwise specified. Preferably at 25° C. and one atmosphere pressure the adsorption bed can take up at least about 5% ammonia by weight, more preferably at least about 10% ammonia by weight, still more preferably at least about 20% ammonia by weight. The weight of adsorbant bed includes the weight of any binders or inert substrates but does not include the weight of any housing or couplings.

The weight of the storage device can be significant. To minimize total weight, the adsorbant preferably accounts for at least about 40% of the ammonia storage device weight, more preferably at least about 60%, and still more preferably at least about 80%.

An ammonia storage device can be charged at a stationary location and mounted on a vehicle or can be charged onboard the vehicle. Where the ammonia storage devices are charged at stationary locations, preferably the one or more ammonia storage devices provided on the vehicle can collectively adsorb at least about 3 kg of ammonia at 1 atmosphere and 25° C., more preferably at least about 6 kg, still more preferably at least about 12 kg. Where the ammonia storage devices are charged onboard, preferably the one or more ammonia storage device on the vehicle can collectively adsorb at least about 0.6 kg of ammonia at 1 atmosphere ammonia and 25° C., more preferably at least about 1.2 kg, still more preferably at least about 2.4 kg.

For safety, the adsorbant is preferably adapted for temperature swing adsorption. An adsorbant that has a capacity for adsorbing NH₃ that changes relatively slowly with pressure but rapidly with temperature is preferred. The heat (energy) of adsorption is a critical factor in determining the temperature increase that will induce desorption. Solid adsorbants generally have a plurality of types of binding sites with a range of heats of adsorption, but an average or approximate value can be determined by analyzing changes in partial pressure with temperature. A larger heat of adsorption means a more rapid increase in partial pressure of adsorbants with temperature. Preferably, the heat of adsorption for NH₃ on the adsorbant is at least about 50 kJ/mol, more preferably at least about 70 kJ/mol, still more preferably at least about 90 kJ/mol.

Any suitable adsorbant material can be used. Examples of adsorbants are molecular sieves, such as zeolites, alumina, silica, and activated carbon. Further examples are oxides, carbonates, and hydroxides of alkaline earth metals such as Mg, Ca, Sr, and Be or alkali metals such as K or Ce. Still further examples include metal phosphates, such as phoshates of titanium and zirconium.

Molecular seives are materials having a crystalline structure that defines internal cavities and interconnecting pores of regular size. Zeolites are the most common example. Zeolites have crystalline structures generally based on atoms tetrahedrally bonded to each other with oxygen bridges. The atoms are most commonly aluminum and silicon (giving aluminosilicates), but P, Ga, Ge, B, Be, and other atoms can also make up the tetrahedral framework. The properties of a zeolite may be modified by ion exchange, for example with a rare earth metal or chromium. While the selection of an adsorbant depends on such factors as the desired adsorption temperature and desorption method, preferred zeolites for ammonia storage generally include faujasites and rare earth zeolites. Faujasites include X and Y-type zeolites. Rare earth zeolites are zeolites that have been extensively (i.e., at least about 50%) or fully ion exchanged with a rare earth metal, such as lanthanum.

The adsorbant is typically combined with a binder and either formed into a self-supporting structure or applied as a coating over an inert substrate. A binder can be, for example, a clay, a silicate, or a cement. Generally, the adsorbant is most effective when a minimum of binder is used. Preferably, the adsorbant bed contains from about 3 to about 20% binder, more preferably from about 3 to about 12%, most preferably from about 3 to about 8%. A preferred composition for small adsorbant pellets that can be used to form monoliths, larger pellets, or a porous coatings over an inert substrate such as screening, is molecular sieve crystals with about 8% or less portland cement as a binder. This composition can provide structural integrity and high utilization of the molecular sieve's adsorption capacity. Where the molecular sieve is H—Y or NH₄—Y zeolite, this mixture can adsorb about 23% NH₃ by weight at 25° C. and one atmosphere ammonia partial pressure. At 350° C. and one atmosphere ammonia partial pressure, the adsorption capacity is reduce to about 5% by weight. H—Y and NH₄—Y zeolites have relatively flat isotherm (small effect of pressure on adsorption capacity), which is advantageous in temperature swing adsorption processes.

According to one aspect of the invention, the ammonia storage devices are charged at stationary plants and interchanged during fuel stops. For these applications, preferably the ammonia storage device is adapted for mounting on a vehicle. Preferably the device can be mounted and dismounted by hand. Hand-operated mounting means can include, for example, clamps, clips, snap-fitting members, sliding connections, interlocking members, and screw connections. A mounting means that involved a small tool mounted on the vehicle or on the ammonia storage device would still be considered a hand-operated mounting means.

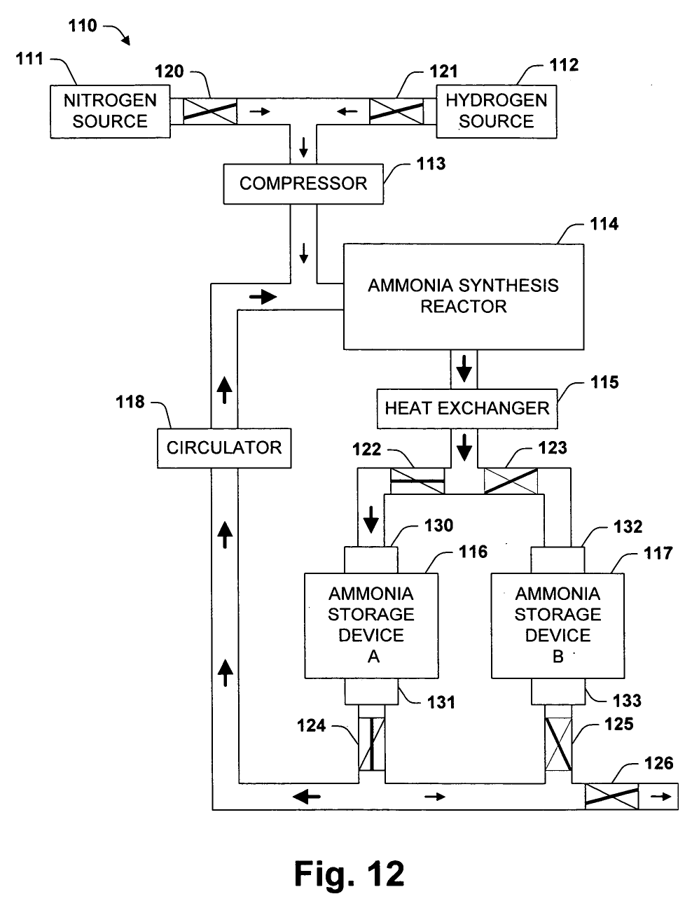

FIG. 12 is a schematic illustration of an ammonia synthesis plant 110 that can be used to charge an ammonia storage device according to the present invention. The ammonia synthesis plant 110 can be mounted on a vehicle or at a stationary location, such as a fuel station. The ammonia storage device 110 comprises a nitrogen source 111 and a hydrogen source 112. Under the control of valves 120 and 122, N₂ and H₂ from these sources are taken up by a compressor 113 and supplied under pressure to a recirculating loop that includes an ammonia synthesis reactor 114 and one of the ammonia storage devices 116 and 117. Recirculation is driven by circulator 118. The circulator 118 can be a simple fan. Alternatively, it can be a compressor.

An optional heat exchanger 115 is provided to cool the recirculating gas as it leaves the ammonia synthesis reactor 114. Cooling can alternatively be provided as the gas leaves the compressor, in the ammonia synthesis reactor 114, in the ammonia storage devices 116 and 117, or elsewhere in the recirculating loop. N₂ and H₂ are partially converted to NH₃ in the ammonia synthesis reactor 114. The ammonia storage device 116 or 117 adsorbs the ammonia produced. Unreacted N₂ and H₂ are returned to the ammonia synthesis reactor 114. A portion of the recirculation gas is released through valve 126 to limit the accumulation of non-reacting impurities.

Valves 122-125 allow one or the other of the ammonia storage devices 116 and 117 to be selectively taken out of the recirculating loop. In FIG. 12, valves 122 and 124 are open while valves 123 and 125 are closed, whereby the ammonia storage device 116 is in the recirculating loop and the ammonia storage device 117 is not. On a vehicle, the ammonia storage device 117 might be used to supply ammonia to an SCR reactor while the ammonia storage device 116 is charging. In a stationary system, the ammonia storage device 117 might be swapped with an ammonia storage device requiring a charge. Optional couplings 130-133 can be used to removably mount the ammonia storage devices 116 and 117 to the ammonia synthesis plant 110.

The nitrogen source is typically a system for obtaining pure nitrogen from air. One simple system is a membrane separator. Other examples include pressure and temperature swing adsorption systems. Typically, such a membrane will also admit argon. The argon concentrates in the recirculating loop and is removed by the purge through the valve 126. A typical purge rate is one part in ten or one part in 20.

The hydrogen source can be a reformer, which can be vehicle mounted. A reformer can convert fuel, such as diesel, gasoline, propane, methane, or natural gas into synthesis gas (syn gas). A reformer can be a catalytic reformer or a plasma reformer. A reformer can use oxygen and/or steam. Relatively pure hydrogen can be extracted from syn gas by any suitable method, for example, temperature or pressure swing adsorption. Hydrogen can also be obtained by electrolysis of water.

The ammonia synthesis reactor 114 comprises a catalyst for the reaction of N₂ and H₂ to for NH₃. The catalyst is provided as a coating on a substrate. Any suitable substrate can be used, including any of the structures described above for ammonia storage devices. A typical structure is a ceramic monolith. Additional options, particularly for stationary applications, are packed and fluidized bed reactors. Examples of potentially suitable catalysts include Group VIII metal compounds, such as a Group VIII metal with a Group VIB metal, Fe optionally with oxides of Al, Mg, Ca, and/or K, Fe₂O₃, Ni with Mo, and Ru with an alkali metal and Ba compound, and molybdenum oxycarbonitride.

Preferably, the ammonia synthesis reactor 114 is designed for operation at a relatively low pressure (for an ammonia synthesis reactor), for example, a pressure of about 100 atm or less, more preferably about 50 atm or less. At these pressures, maximum conversion may be in the 5-30% range. Adsorption in ammonia storage devices and recirculation of reagents allows the reagents to be efficiently used in spite of low conversions.

The exemplary ammonia synthesis plant 110 includes two ammonia storage devices 116 and 117. At any given time, one can be charging and the other can be supplying ammonia or undergoing exchange. Optionally, more than two ammonia storage devices can be provided with one or more charging and one or more discharging, waiting, or undergoing exchange.

Desorption from an ammonia storage device to supply ammonia can be carried out in any suitable manner, however, a temperature change is preferred. Desportion can also be controlled in any suitable manner. For example, a heating device can be selectively actuated to maintain a target pressure, e.g., 15 psig, of ammonia while a valve is used to control the flow rate of ammonia to a SCR reactor. A state of discharge can be detected through a fall off in concentration or a fall off in pressure. Alternatively, a state of discharge can be estimated from data relating to usage. For example, knowing the pressure in the ammonia storage device and the position of a discharge valve as a function of time can provide the information from which the degree of discharge is estimated. Likewise, during charging, a state of complete charge can be determined either from sensors or estimates.

The invention has been shown and described with respect to certain aspects, examples, and embodiments. While a particular feature of the invention may have been disclosed with respect to only one of several aspects, examples, or embodiments, the feature may be combined with one or more other features of the other aspects, examples, or embodiments as may be advantageous for any given or particular application.

1. An ammonia storage device, comprising:
an adsorption bed contained in a housing;
wherein the adsorption bed has the capacity to store at least about 10% ammonia by weight at 25° C. and one atmosphere pressure; and
the device is adapted for use in a vehicle exhaust system.

2. The device of claim 1, wherein the device weighs no more than about 80 lbs.

3. A vehicle on which is mounted a device according to claim 1.

4. The vehicle of claim 3, wherein the adsorption bed contains at least about 10% adsorbed ammonia by weight.

5. The vehicle of claim 3, wherein the device has an adaptation for heating selected from the group consisting of wire leads for electrical resistance heating and one or more heat exchange passages passing through the adsorption bed in fluid isolation from the bed.

6. The vehicle of claim 3, wherein the capacity of the bed to store ammonia at 350° C. and one atmosphere pressure is about half or less its capacity to store ammonia at 25° C. and one atmosphere pressure.

7. The vehicle of claim 3, wherein the capacity of the bed to store ammonia at 350° C. and one atmosphere pressure is about a third or less its capacity to store ammonia at 25° C. and one atmosphere pressure.

8. The vehicle of claim 3, wherein the capacity of the bed to store ammonia at 350° C. and one atmosphere pressure is about a quarter or less its capacity to store ammonia at 25° C. and one atmosphere pressure.

9. The vehicle of claim 3, wherein the adsorption bed has the capacity to store at least about 20% ammonia by weight at 25° C. and one atmosphere pressure.

10. A method of providing ammonia to an SCR reactor in a vehicle exhaust system, comprising:
adsorbing ammonia into an adsorption bed;
increasing the temperature of the adsorption bed to desorb ammonia; and
supplying the ammonia to the SCR reactor.

11. The method of claim 10, wherein adsorbing ammonia on the adsorption bed comprises adsorbing at least about 10% ammonia by weight into the bed.

12. The method of claim 10, wherein adsorbing ammonia into the adsorption bed comprises placing the adsorption bed in a recirculating stream that passes through an ammonia synthesis reactor.

13. The method of claim 10, wherein increasing the temperature of the adsorption bed comprises electrically heating the reactor.

14. The method of claim 10, wherein increasing the temperature of the adsorption bed comprises exchanging heat with vehicle exhaust by passing the vehicle exhaust through the adsorption bed through passages in fluid isolation from the bed.

15. The method of claim 10, wherein increasing the temperature of the adsorption bed comprises heating the adsorption bed to at least about 300° C.

16. The method of claim 15, wherein adsorbing ammonia into the adsorption bed comprises adsorbing ammonia to an extent that gives an ammonia charge in equilibrium with a partial pressure less than one atmosphere at 25° C.

17. The method of claim 16, wherein adsorbing ammonia into the adsorption bed comprises adsorbing at least about 10% ammonia by weight into the adsorption bed.

18. The method of claim 10 wherein adsorbing ammonia into an adsorption bed takes place off the vehicle and increasing the temperature of the adsorption bed to desorb ammonia takes place on the vehicle.

19. The method of claim 10, wherein adsorbing ammonia takes place at a temperature at or below 100° C.

20. The method of claim 19, wherein adsorbing ammonia takes place on the vehicle.

21. A method of supplying ammonia to vehicles for SCR of NOx, comprising:
charging with ammonia an ammonia storage device that stores ammonia by adsorbing it on an adsorption bed;
installing the ammonia storage device on the vehicle;
reducing NOx generated by the vehicle with ammonia from the storage device.

22. The method of claim 21, wherein reducing NOx generated by the vehicle with ammonia from the storage device comprises desorbing ammonia from the device and reacting the ammonia with NOx in a reactor outside the storage device.

23. The method of claim 22, wherein desorbing ammonia from the device comprises increasing the temperature of the adsorption bed to at least about 300° C.

24. The method of claim 23, wherein charging the ammonia storage device comprises adsorbing ammonia to an extent that gives an ammonia charge in equilibrium with a partial pressure less than one atmosphere at 25° C.

25. The method of claim 24, wherein charging the ammonia storage device takes place at a temperature at or below 100° C.

26. The method of claim 21, wherein charging the ammonia storage device comprises adsorbing at least about 10% ammonia by weight into the bed.

27. The method of claim 21, wherein charging the ammonia storage device comprises placing the storage device in a recirculating stream that passes through an ammonia synthesis reactor.

28. A vehicle, comprising:
an internal combustion engine providing the vehicle with motive power and producing exhaust;
an SCR reactor adapted to catalyze a reaction between NOx drawn from the exhaust and ammonia;
an ammonia storage device comprising an adsorption bed for adsorbing ammonia and configured to selectively desorb ammonia to supply the SCR reactor; and
an ammonia synthesis reactor adapted to produce an output gas containing ammonia;
wherein the vehicle is adapted to route the output gas through the ammonia storage device and recycle most of the unadsorbed components of the output gas back into the ammonia synthesis reactor.

29. The vehicle of claim 28, wherein the vehicle is adapted to supply the ammonia synthesis reactor with N₂ and H₂ and form ammonia from these components.

30. The vehicle of claim 29, wherein the vehicle is designed to operate the ammonia synthesis reactor at a pressure of about 100 atmospheres or less.

31. The vehicle of claim 29, wherein the vehicle is designed to achieve no more than about a 30% conversion of a pure stoichiometric mixture of N₂ and H₂ to ammonia during normal operation.

32. The vehicle of claim 28, wherein the ammonia storage device is adapted to store at least about 10% adsorbed ammonia by weight at 25° C. and one atmosphere pressure.

33. A vehicle, comprising:
an internal combustion engine providing the vehicle with motive power and producing exhaust;
an SCR reactor adapted to catalyze a reaction between NOₓ drawn from the exhaust and ammonia;
at least two ammonia storage devices each comprising an adsorption bed for adsorbing ammonia; and
wherein the vehicle is adapted to supply ammonia from a first of the ammonia storage devices to the SCR reactor and, at some point during vehicle operation, to switch to supplying ammonia from a second of the devices

34. The vehicle of claim 33, wherein the ammonia storage devices are each adapted to store at least about 10% adsorbed ammonia by weight at 25° C. and one atmosphere pressure.

35. The vehicle of claim 33, wherein the point during vehicle operation corresponds to depletion of the available ammonia in the first of the devices.

36. The vehicle of claim 33, further comprising an ammonia synthesis reactor, wherein the vehicle is adapted to charge the first of the ammonia storage devices with ammonia from the ammonia synthesis reactor after switching to supplying ammonia from the second of the devices.

37. The vehicle of claim 36, wherein the vehicle is adapted to cool the first of the ammonia storage devices prior to charging the device with ammonia.

38. The vehicle of claim 33, wherein the adaptation for supplying ammonia from the first of the ammonia storage devices to the SCR reactor comprises an adaptation for heating the first of the ammonia storage devices.

39. The ammonia storage device of claim 1, wherein the adsorption bed comprises an effective amount of a faujisite.

40. The ammonia storage device of claim 39, wherein the adsorption bed comprises an effective amount of a Y-type zeolite.

41. The ammonia storage device of claim 1, wherein the adsorption bed comprises an effective amount of a rare earth zeolite.

42. The ammonia storage device of claim 41, wherein the adsorption bed comprises an effective amount of a lanthanum zeolite.
